(19) United States
(12) Patent Application Publication
(10) Pub. No.: US 2008/0262995 A1
(43) Pub. Date: Oct. 23, 2008

(54) Multimodal rating system

(75) Inventors: Geoffrey Gerson Zweig, Sammamish, WA (US); Yun-Cheng Ju, Bellevue, WA (US); Patrick Nguyen, Redmond, WA (US); Alejandro Acero, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/788,325

(22) Filed: Apr. 19, 2007

(51) Int. Cl. G06F 17/30

(52) U.S. Cl. 707/1; 707/E17.044

(57) ABSTRACT

A method of communicating information about a product evaluation between a system having a data store and a wireless client device is discussed. The method includes receiving a signal representative of an audible indication from the client device via a wireless communication link identifying the product about which evaluation information is to be communicated. The method further includes comparing an indication of the signal to data in the data store in response to match the indication with a portion of the data and communicating evaluation information between the wireless client device and the system.

### BACKGROUND

Rating systems now accessible over wide area networks such as the Internet provide a valuable service by allowing consumers to share their assessments of goods and services. Consumers can provide evaluations of such products, which allow other prospective consumers to make more informed purchasing decisions. Access to such rating systems typically requires that the prospective consumer use a web interface such as can be provided by a laptop or desktop computer.

Unfortunately, because most consumers do not have access to such a web interface while shopping. Furthermore, while some mobile phones may provide web access, their small screens make them inconvenient or impractical to use for accessing rating systems. Therefore, such rating systems, while providing information for well-planned purchases, are not easily accessible by prospective consumers.

The discussion above is merely provided for general background information and is not intended to be used as an aid in determining the scope of the claimed subject matter.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

In one illustrative embodiment, a method of communicating information about a product evaluation between a system having a data store and a wireless client device is discussed. The method includes receiving a signal representative of an audible indication from the client device via a wireless communication link identifying the product about which evaluation information is to be communicated. The method further includes comparing an indication of the signal to data in the data store in response to match the indication with a portion of the data and communicating evaluation information between the wireless client device and the system.

In another illustrative embodiment, a system for providing information related to a product evaluation to a remote device is discussed. The system includes a data store configured to store data related to a product evaluation and an engine configured to receive a signal indicative of a request for communication from the remove device. The system further includes a communication link capable of communicating with a remote device to communicate information related to a product evaluation between the data store and the remote device in response to the signal indicative of the request. The information is provided to a text to speech engine.

In still another illustrative embodiment, a method of receiving information related to a product evaluation at a wireless device remote to a data store that stores the information is discussed. The method includes sending a request signal indicative of the product to a system having a data store and receiving a signal indicative of the information from the system. The signal includes information related to a rating of the product.

### BRIEF DESCRIPTION OF THE DRAWINGS

FIG. 1 is a block diagram illustrating a system for collecting and communicating multimodal information relative to a product or service rating service according to one illustrative embodiment.

FIG. 2 is a block diagram of illustrating a client device capable of interfacing the system of FIG. 1.

FIG. 3 illustrates a portion of data structure storing information related to the rating service of FIG. 1.

FIG. 4 illustrates another-portion of the data structure of FIG. 3.

FIG. 5 is a flowchart illustrating a method of collecting and disseminating information from the rating system of FIG. 1.

FIG. 5A is a flowchart illustrating a method of providing information from the rating system of FIG. 1 other than that requested by the user.

FIG. 6 is a block diagram of one computing environment in which some embodiments may be practiced.

### DETAILED DESCRIPTION

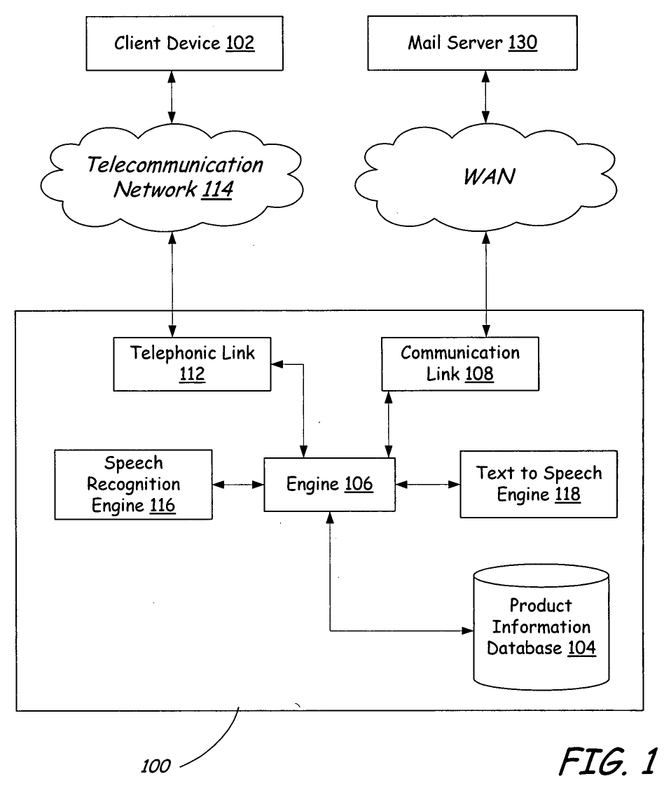

FIG. 1 illustrates a multi-modal rating system 100 for providing information related to various products and services to a remote client device 102 according to one illustrative embodiment. The multi-modal rating system 100 includes a product and service information data store 104, which in turn includes information about a variety of products and services that is accessible by the remote client device 102. The details of the type of information stored in the product and service information data store 104 will be discussed below. The information stored on the product and service information data store 104 is illustratively accessible by an engine 106, which provide at least a portion of the stored information to the client device 102 in response to a request from the client device 102. The product or service information data store 104 illustratively includes information that is intended to be provided to the remote client device 102 in a number of different formats, which illustratively includes text, audio, and visual. The product or service information data store 104 is shown as a single data store for illustrative purposes. The storage of information related to products or services can be stored in any number of storage devices and organized in any manner within the storage devices without departing from the spirit and scope of the invention.

The multi-modal rating system 100 also includes a communication link 108, which, in one embodiment, is capable of accessing a wide area network (WAN) 110 to communicate with devices outside of the system 100. In one illustrative embodiment, the WAN 110 is the Internet, although any other WAN can be employed without departing from the scope of the disclosed embodiments herein. The system 100 also illustratively includes a telephonic communication link 112, which is configured to communicate over a telecommunication network 114. The communication link 108 and the telephonic link 112 described here are provided for illustrative purposes. It should be appreciated that system 100 can include any type of communication links without departing from the scope of the disclosure. For example, the system 100 can include either or both communication links, or system 100 can include neither of the communication links.

System 100 also illustratively includes a speech recognition engine 116, which is configured to receive an audio input and return a textual output. For example, if the client device 102 provides an indication that includes audio information, the engine 106 will provide the audio information to the speech recognition engine 116 is configured to process the audio information and return a textual representation of the audio information to the engine 106.

In addition, system 100 of the current embodiment includes a text-to-speech engine 118. The text-to-speech engine 118 illustratively receives a textual indication from the engine 106 and converts the textual indication into a synthesized audio representation of the text. The engine 106 is capable of interfacing with the product or service information data store 104 to store and retrieve textual and audio indications. In addition, other types of files received through the communication links 108 and 112 are illustratively received by the engine 106 and stored in the product or service information data store 104.

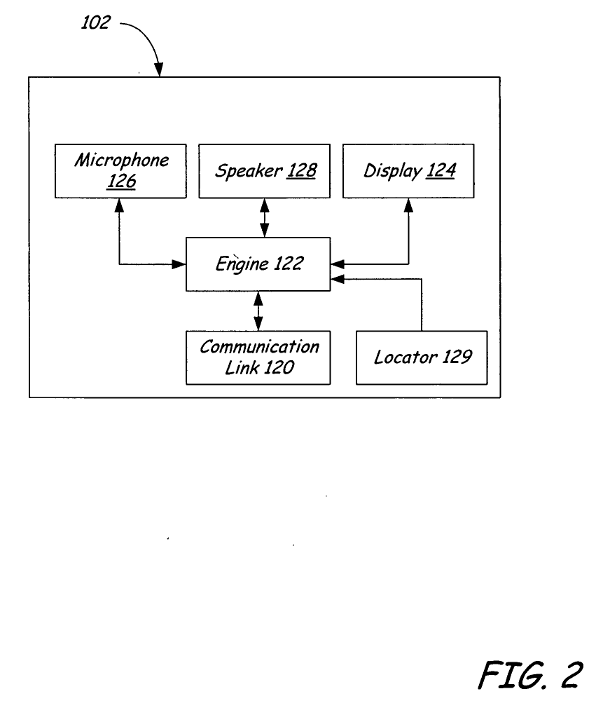

FIG. 2 illustrates one embodiment of the client device 102 in more detail. Client device 102 illustratively includes a communication link 120 that is configured to interface with a communication network such as telecommunication network 114. The client device 102 is, in one illustrative embodiment, a cellular telephone although the client device 102 can be any number of different types of devices, including, for example, a personal digital assistant (PDA), a personal computer or other similar types of devices.

The client device 102 includes an engine 122, which is configured to communicate with the communication link 120. In one illustrative embodiment, the communication is provided by establishing a telephone connection between the client device 102 and the system 100. Alternatively or in addition, the client device 102 can access a web page supported by the system 100 for the purposes of communication information with the system 100. In addition, the engine 122 is configured to provide data to a display 124. The display 124 is capable of displaying still or moving images provided to it from the engine 122. The client device also illustratively includes a microphone 126, which is capable of receiving an audio signal and providing that signal to the engine 122. The engine 122 is also capable of sending the indication of the audible signal to the system 100 through the telecommunication network 114. The client device 102 also illustratively includes a speaker 128 capable of providing an audible sound from, for example, an audio indication received by the client device 102 from the system 100. Client device also illustratively includes a locator 129, which can provide information about the geographic location of the client device to the engine 122.

Although not shown in FIG. 2, the client device 100, in one illustrative embodiment, also includes a communication link between the client device 102 and WAN 110. The communication link to the WAN can be accomplished in any acceptable way. As an example, the communication link can be established through the communication link 120 or through some other acceptable link. Returning again briefly to FIG. 1, a mail server 130 is shown in communication with the WAN 110. Mail server 130 is one of many devices that can be accessible through the WAN 110. Mail server 130 is advantageously provided to receive information from the system 100, which will be discussed in more detail below.

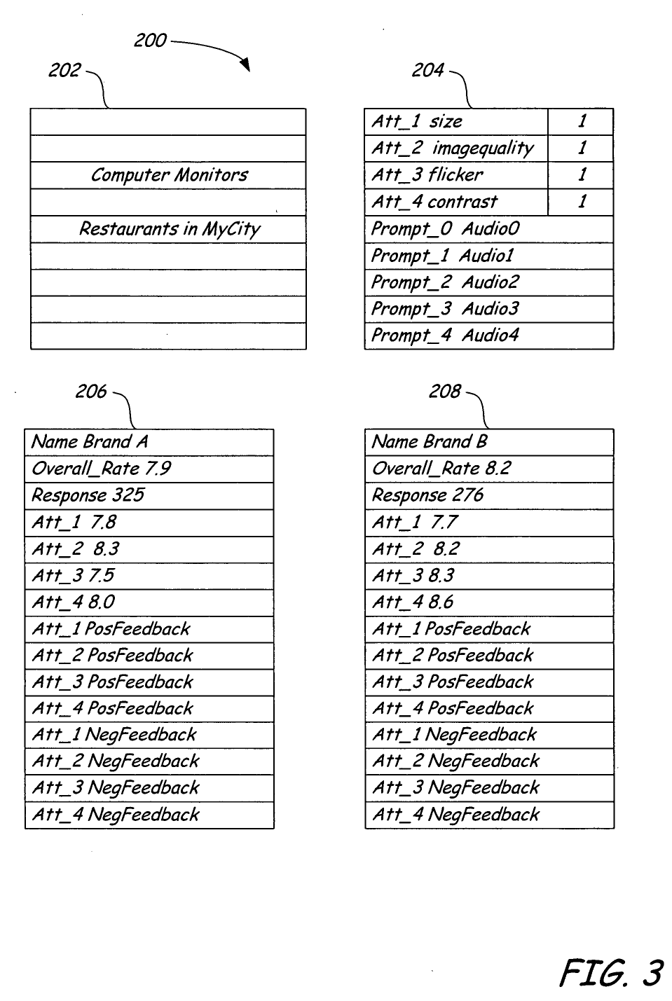

FIG. 3 illustrates an example of a portion of a data structure 200 in the product or service information data store 104 according to one illustrative embodiment. The data structure 200 includes a table 204, which illustratively includes categories of data stored in the product or service information data store 104. The data stored in data structure 200 can be provided from a variety of sources. For example, data can be retrieved from databases collected from expert analysis of products, from marketing research efforts, or from consumers who access the system 100 to provide feedback information about a product or a service. The final source of data, that provided by consumers, will be discussed in more detail below. It should be recognized that multiple sources can be used to retrieve and update the information in data structure 200 of product or service information data store 104.

Table 204 specifies two illustrative categories: “Computer Monitors” and “Restaurants in MyCity” and illustrates a single layer of categories. That is, the categories listed in table 204 do not illustrate any subcategories. It should be appreciated, though, that the categories collected in the table 204 in alternative embodiments can include a structure with multiple layers of categories. For example, the table 204 can be divided into products and services. In addition, the table 204 can be divided into locations such as local restaurants or restaurants in “MyCity”, where the name “MyCity” represents the name of a particular city. Further, large groups of products, such as consumer electronics, can be further subdivided into computer accessories and so forth until the subcategory “computer monitors” is sub-categorized.

Tables 204, 206, and 208 provide an illustrative example of information arranged and stored in product or service information data store 104 for the category of “Computer Monitors”. Table 204 stores information relative to the Computer Monitors category in general. Four criteria have been illustratively shown as being relevant to the evaluation of computer monitors: size, image quality, flicker and contrast. Each of these criteria is defined as an attribute. In addition, each attribute is illustratively assigned a weight, which provides a relative importance of the attribute. In the illustrative example, each attribute has a weight of “1”, indicating that each attribute has the same relative weight. It should be understood that each attribute can have any particular value irrespective of the values of any of the other attributes. Alternatively, the sum of all of the attribute weights necessarily must add up to a given sum.

Table 204 also includes a series of prompts, from prompt_0, which provides a prompt indicative of a prompt for a given entry in the category. For example, suppose that the first entry in the product or service information data store 104 under the category “Computer Monitors” is named “Brand A”. The prompt_0 would then have the name “Brand A” stored as prompt_0. In one embodiment, each of the prompts is stored as audio files in the product or service information data store 104. Alternatively, the prompts are stored as text indications of the sound. Each of the next four prompts is related to the attributes. For example, prompt_1 is illustratively an audio file representing the pronunciation of the attribute “size”. The prompts are illustratively used to prompt a consumer for information or to provide context for information that is provided to the consumer through the client device 102.

Table 206 illustrates information stored relative to a first computer monitor known as Brand A. The table includes an overall rate of 7.9. The overall rate is illustratively calculated by multiplying the attribute value assigned to each of the attributes by their relative weights and adding the weighted attribute values together. The relative weight for each attribute is then multiplied against the value assigned to that attribute. Each attribute is similarly operated upon and the sum of all the attributes is calculated. Then, the sum is divided by the sum the weight attribute values to get the Overall_Rate.

Table 206 thus illustratively includes information about the relative value of each of the defined attributes as well as data related to positive and negative feedback. For example, Att_1PosFeedback is a field that includes information related to positive feedback given relative to the first attribute, which in this case is the size of the monitor. Att_1NegFeedback is a field that includes information related to negative feedback. The information stored in each of these fields is illustratively available for output to the client device as necessary and as will be discussed in more detail below. Alternatively, one or more categories in the product or service information data store 104 may not have numerical values provided to attributes, instead having a single rating number, the Overall_Rate, for each entry in a particular category. Thus, it should be understood that in some embodiments no categories have numerical values assigned to individual attributes.

Table 208 illustrates information stored relative to a second computer monitor known as Brand B. The second computer monitor has an overall score of 8.2 based upon 276 responses. The average score for the four attributes are 7.7, 8.2, 8.3, and 8.6, respectively. As with the first computer monitor entry, the second monitor entry includes information related to positive and negative feedback for each of the attributes.

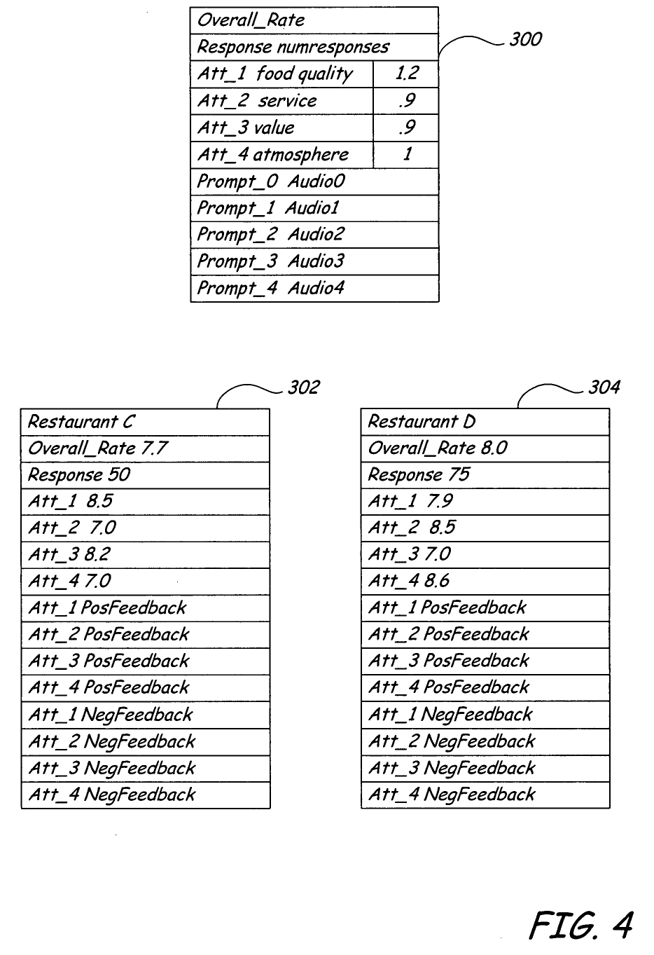

FIG. 4 illustrates tables 300, 302, and 302, which include illustrative information stored in product or service information data store 104 under the category “Restaurants in MyCity” according to one illustrative embodiment. The “Restaurants in MyCity” category illustratively has four attributes: food quality, service, value, and atmosphere. Unlike the examples provided above with respect to the computer monitor category, the attributes have different weights, indicating that food quality is the most important category, followed by atmosphere, with service and value deemed to be equally important.

Table 302 illustrates the stored data for Restaurant C and table 304 illustrates stored data for Restaurant D. Each of the attributes have been assigned values that are indicative of the responses that might have been provided for the attributes assigned to the “Restaurants in MyCity” category. The information provided in these tables will be discussed in more detail below.

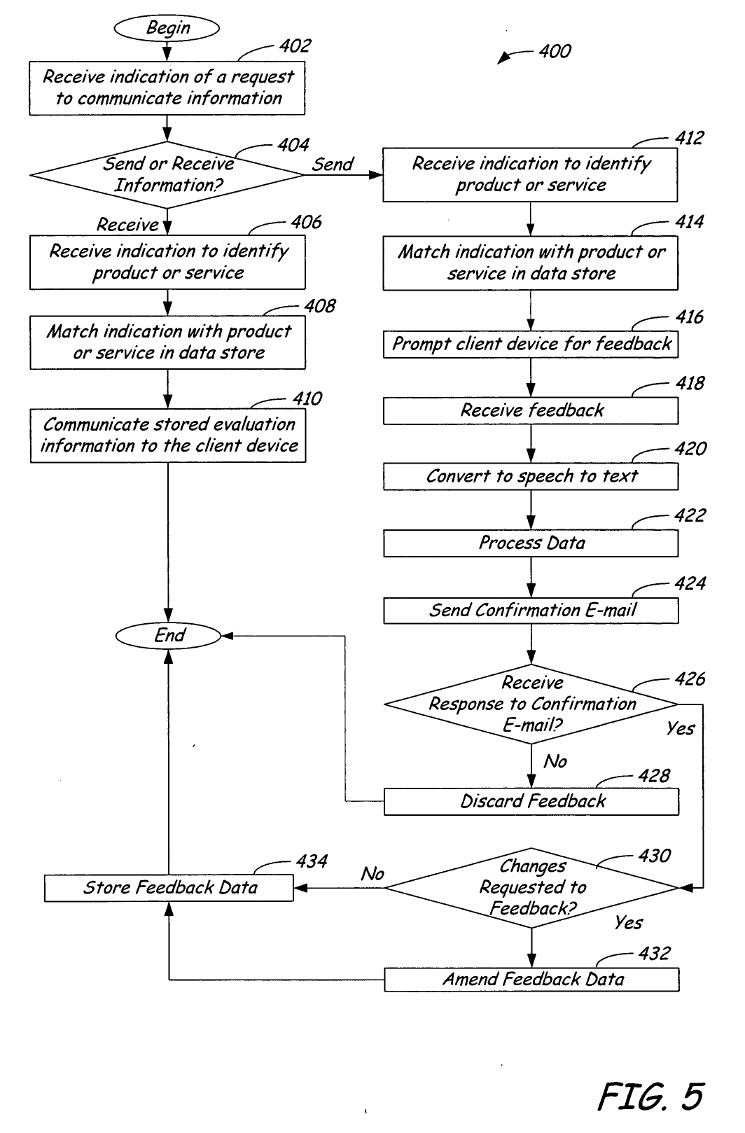

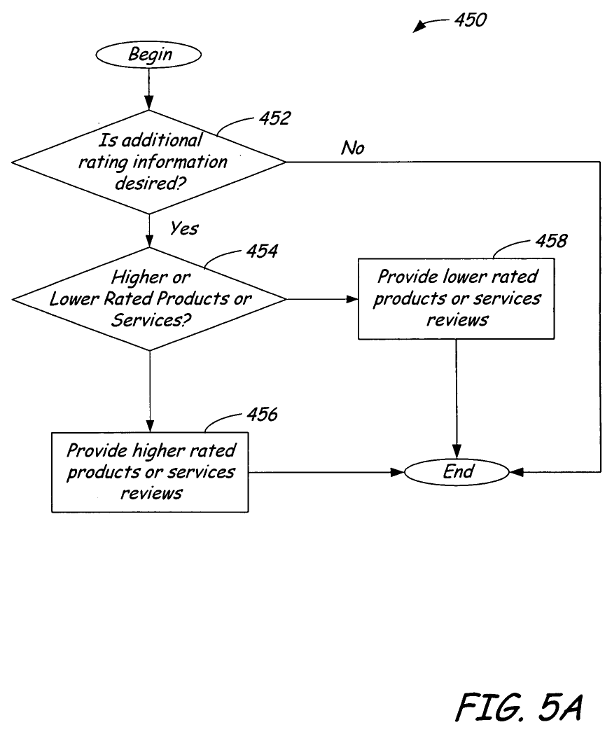

FIG. 5 illustrates a method 400 of receiving feedback on a product or service from a client device 102 provided to the system 100 (as shown in FIG. 1) according to one illustrative embodiment. The system 100 illustratively receives a signal from the client device 102 indicative of a request to communicate information between the client device 102 and the system 100, which is represented by block 402. The system 100 evaluates the signal provided from the client device 102 to determine whether the request is to initiate a communication to send information to or receive information from the client device 102 to the system 100. This is illustrated in block 404.

If it is determined that the request is for initiating a communication to send information to the client device 102, the system 100 receives an indication from the client device 102 that identifies the product or service for which a consumer using the client device 102 wishes to receive evaluation information. The indication can indicate an audible or visual signal or a data entry such as a keystroke provided by the client device 102. This is indicated in block 406.

The system 100 then compares the indication received from the client device 102 with information stored in the data store 104 to find a match with a product or service previously stored in the data store 104. This is indicated in block 408. The system 100 illustratively uses its speech recognition engine 116 to attempt to identify the product or service about which the consumer wishes to provide information. The system 100 illustratively provides an algorithm to discern the proper product or service through speech recognition, which may include prompting the consumer to verify the speech recognition results.

Alternatively, the system 100 provides prompt messages to lead the consumer through a multi-level category map until the proper product is located. Alternatively still, the consumer may be provided the option of sending a picture of the product to the system 100, which the engine 106 can attempt to compare with visual data stored in the product or service information data store 104 for the purposes of identifying the product. If there is no match, the system 100 either has no data for a particular product or service or the client device 102 has provided a signal that fails to identify previously stored data. The system 100 can then prompt the client device 102 for another signal, or alternatively conclude a communication with the client device 102.

Once the system 100 has determined a match between the indication and information stored in data store 104, the system 100 illustratively communicates evaluation information to the client device 102. This is illustrated in block 410. The information illustratively includes a numerical ranking and/or a verbal description of one or more attributes of the product or service. The information, in one illustrative embodiment, is communicated from the system 100 to the client device 102. The information is illustratively communicated as an audible transmission, which includes a verbal description of the stored information. Alternatively or in addition, the information provided to the client device 102 can include visual information including a still or motion picture depicting the product or service or a visual representation of a numerical rating and/or a verbal description of the product or service. In addition, the stored information can provide an indication, such as an audible jingle or a visual mark, which identifies the product or service and/or the company that provides the product or service.

Alternatively, the communication at 410 can include location specific information. As discussed above, the client device 102 can include a locator 129, which provides location information. If it is determined that the client device 102, and hence the user, is in a particular retail location, the communication at block 410 illustratively provides any location specific information. For example, a particular store may have a current sale on the requested product or service. That information is then illustratively communicated to the client device 102. Such information may be provided under any circumstances or alternatively, for example, when the store provides previous consideration.

In one illustrative embodiment, the feedback provided by the system 100 highlights both a positive and a negative aspect of a particular item in a template form. Consider, for example, the tables 302 and 304, which represent information stored regarding Restaurant C and Restaurant D, respectively. Restaurant C has an overall rating of 7.7. Restaurant C had a highest rating in food quality and a lowest rating in service and atmosphere. The feedback provided by the system 100 would illustratively be as follows.
“Restaurant C has an overall rating of 7.7. People give Restaurant D its highest marks for food quality and its lowest marks for atmosphere and service.”
   For Restaurant D, the feedback would be as follows.
“Restaurant D has an overall rating of 8.0. People give Restaurant D its highest marks for atmosphere and its lowest marks for value.”
   In addition, the system 100 illustratively provides positive and negative comments for the highest and lowest rated functions, respectively. Alternatively or in addition, the system 100 provides the user the opportunity to hear more feedback provided, including positive and negative comments about every attribute recorded in the product or service information data store 104.

In another illustrative embodiment as illustrated in FIG. 5A, the system 100 provides the consumer with a method 450 of receiving evaluation information about products that are similar to the product requested. Method 450 is illustratively performed after receiving information about the requested product as shown in block 410 of FIG. 5. Method 450 illustratively begins by inquiring whether a user wishes to receive additional ratings, as is shown in block 452. The inquiry is, in one embodiment, initiated by providing an audible prompt from the system 100 to the client device 102. Alternatively or in addition, a visual prompt can be provided to the client device.

If the user indicates a desire to receive evaluations about other similar products or services, a prompt is provided to the user to determine whether evaluations of higher or lower rated products or services are desired. This is represented by block 454. If higher rated products or services evaluations are desired, they are provided as is shown in block 456. In one embodiment, the higher rated evaluations are provided only when the user has provided consideration. Alternativley, the higher rated evaluations are provided without regard for consideration. If lower rated products or services evaluations are desired, the are provided as is shown in block 458. In one embodiment, all related products or services having higher or lower evaluations are provided. Alternatively, only a subset of the related products or services having higher or lower evaluations is provided. As an example, the subset of evaluations provided can be limited to those products or services whose providers have provided previous consideration to be part of such a subset.

Consider for example, the case where the consumer requests information about Brand A computer monitor. The system 100 illustratively provides information about the Brand A computer monitor. Because Brand B computer monitor has a higher rating, the system 100 illustratively asks the consumer if he wishes to get information on the more highly rated product. While the information provided is illustratively evaluation information, alternatively advertising information about additional products or services can be provided.

In still another illustrative embodiment, the system 100 can request information from the consumer relative to his or her preferences. For example, when the consumer requests information relative to a restaurant, the system 100 illustratively inquires about which attribute or attributes are more important. Based on the information provided by the consumer, the attribute weights can be adjusted. In addition, if one attribute is more important than others are, the selection of that attribute can trigger a suggestion for the system 100 to make to the consumer. As an example, suppose the consumer requested information about Restaurant D and indicated that food quality was the most important attribute. Ordinarily, since Restaurant D has a higher overall rating, system 100 wouldn't recommend Restaurant C. However, because Restaurant C has a higher food quality, system 100 would now recommend the Restaurant C. The system 100, in one embodiment, inquires about attributes after a consumer has received evaluation information. Alternatively, the system inquires about attributes after a consumer has provided evaluation information, as shown in block 418.

Returning to block 404, if it is determined that the request is for initiating a communication to receive information from the client device 102, the system 100 receives an indication from the client device 102 that identifies the product or service for which a consumer using the client device 102 wishes to provide evaluation information. The indication can indicate an audible or visual signal or a data entry such as a keystroke provided by the client device 102. The indication can be received This is illustrated in block 412.

The system 100 then compares the indication received from the client device 102 with information stored in the data store 104 to find a match with a product or service previously stored in the data store 104 using any acceptable method of comparing the data, including those discussed above. This is indicated in block 414. If there is no match, the system 100 either has no data for a particular product or service or the client device 102 has provided a signal that fails to identify previously stored data. The system 100 can then prompt the client device 102 for another signal, or alternatively conclude that the client device 102 is providing information about a previously unreviewed product or service.

Once the product or service has been identified, the system 100 illustratively prompts the client device 102 for feedback information, as is illustrated in block 416. The prompt provided by the system 100 includes a request for one or more numerical values to describe a rating for the product or service. For example, the particular category may require that the user evaluate a number of attributes for the given product or service by numerically rating the item. Alternatively, or in addition, the prompt can include a request for an audible indication that provides more qualitative feedback from the consumer. For example, the system 100 may prompt the consumer to provide responses to directed qualitative questions about a particular attribute of the product or service, or the system may prompt the consumer to provide more open ended feedback. Alternatively still, the prompt illustratively requests a visual indication of the product or service to be evaluated.

In response to the received request, the system 100 illustratively receives feedback from the consumer as is illustrated in block 418. In one illustrative embodiment, the feedback provided by the consumer through the client device 102 matches the type of information requested by the system 100. Alternatively, the feedback received by the system 100 is not of the type of information requested by the system 100. In such a case, the system 100 requests that the client device 102 re-transmit the feedback, which can include requesting that the consumer provide the feedback once again. Alternatively, the system 100 will abort the feedback process. It should be appreciated that in some embodiments, the system 100 will request more than one type of feedback. It should also be appreciated that the system 100, in some embodiments, prompts the client device 102 to have the consumer indicate the type of feedback that the consumer wishes to provide.

The prompt for information step illustrated in block 416 and the reception of feedback illustrated in block 418 can be repeated several times during the collection of feedback information from the consumer. For example, when evaluating a particular product, it may be advantageous to get a numerical rating not only for the product as a whole, but also for individual features within the product. For example, an evaluation of a computer monitor may have an overall rating, but rating or describing certain features of the computer monitor can advantageously provide valuable information for consumers who may want to know about these features when making a purchase decision. Therefore, an illustrative example of prompting for feedback includes a first prompt, which prompts the consumer to identify the size of the computer monitor. A second prompt requests the consumer to evaluate the image quality of the computer monitor, for example, on a scale from one to ten. A third prompt requests the consumer to evaluate the flicker of the computer monitor on a scale from one to ten. A fourth prompt requests the consumer to evaluate the contrast of the computer monitor on a scale of one to ten. Alternatively, more, fewer, or different prompts for information may be employed. In addition, the system 100 illustratively prompts the consumer, through the client device 102 to provide additional feedback about each of the particular features described above, as well as for the monitor overall.

In some embodiments, specific product information out can be provided. For example, a provider of a product or service may provide a specific pronunciation recording of a product or service that might not otherwise be pronounceable by the text to speech engine 118. In addition, a recording can illustratively include ancillary features such as an audible jingle.

In one illustrative embodiment, the process of prompting the client device 102 for feedback in block 416 illustratively includes additional prompting of the client device 102 to acquire information related to the product category, as opposed to the specific product in question. For example, the system 100 may prompt the client device 102 to ask the consumer a question related to computer monitors in general such as, for example, what types of features are important to the consumer when evaluating computer monitors. Alternatively, or in addition, the system 100 illustratively prompts the client device 102 to evaluate features against each other. For example, the system 100 prompts the client device 102 to determine whether the consumer rates flicker or image contrast as a more important feature for a computer monitor. The system 100 will then receive feedback to the questions prompted to the client device 102.

Once the system 100 has successfully received feedback from the consumer, the system 100 will convert any audible feedback into a text string by employing the automatic speech recognizer engine 116 to analyze the audible input. This is shown in block 420. Once the audible indication has been converted to a text string, the text string is processed to extract feedback information from the text string. This is indicated by block 422. In one illustrative embodiment, the system 100 analyzes the provided text string for keywords and extracts phrases having the keywords to collect the feedback information. The extraction process is illustratively performed automatically by the system 100. Alternatively, the text string is manually analyzed to extract the relevant information.

After the text string has been analyzed, the system 100 illustratively provides the consumer an opportunity to confirm the feedback that has been provided. In one illustrative embodiment, the system 100 provides an e-mail copy of the text string to the consumer for evaluation to e-mail server 130. This is illustrated in block 424. The consumer is thus illustratively afforded the opportunity to confirm the feedback and/or make any changes to the feedback that the consumer wishes by accessing the e-mail server 130, either through the client device 130 or another device. The system 100 then illustratively waits for a response to the confirmation e-mail from the consumer, which is illustrated in block 426. Alternatively, the system 100 will send another form of communication using any acceptable means of communication, such as, for example, sending a text message to the consumer. The consumer can illustratively select the type of confirmation message that he wishes to receive.

If the system 100 receives the response from the consumer, the system 100 illustratively examines the response to determine whether the consumer has provided any changes to the original feedback. This is illustrated in block 430. If the consumer has provided a change to the original feedback, the system 100 processes the feedback data to account for the amendments made to the original feedback. This is illustrated in block 432. The amended data is then stored by the system 100, as is shown in block 434. Returning to block 430, if the consumer did not provide amendment to the original feedback, the previously processed data is stored by the system 100 at block 434. Returning to block 426, if the consumer does not provide a response to the confirmation e-mail, the system 100 illustratively discards the feedback data, as is shown in block 428.

Referring again to block 432, once the data provided by the consumer is verified, the data is stored into the product or service information data store 104. For numerical data, the data is averaged into previously acquired data so that the stored data values illustratively represent an average of all of the data points collected. For text data received in response to a directed question, the textual response is analyzed for key phrases that represent either positive or negative feedback. The feedback is then illustratively combined with previously collected data and saved in a succinct statement of either a positive or negative evaluation of a particular attribute. In one embodiment, the data stored in product or service information data store 104 is a textual representation. Alternatively, the textual representation is provided to the text-to-speech engine 118, which synthesizes the textual representation into an audio file. The audio file is then stored into the product or service information data store 104.

For text data received in response to an open-ended question, the textual response is analyzed for key phrases that represent particular attributes as well as positive or negative feedback. Once the data is analyzed to determine both an attribute and the type of feedback provided, it is handled as described above with respect to responses from directed questions. In some situations, it may be advantageous to provide an audio representation to the system 100 for direct storage in the product or service information data store 104 without being subjected to speech recognition and text-to-speech conversions. For example, suppose that a new product or service is being added to the data store that has a uniquely pronounced name. Such a name may not be properly synthesized. Therefore, by providing an audio file for storage in the product or service information data store 104, a proper pronunciation can be assured. In addition, a company can provide a jingle or other embellishments to the audio file, if desired.

Although the method described above is focused on the task of receiving an evaluation of an identified product to fit into the attributes that are predefined with respect to the product, alternatively or in addition the system 100 can retrieve other information relative to the data structure. For example, it may be useful to determine what attributes are most important to consumers. By knowing such information, the weights of a model can be altered.

The present embodiments provide several important advantages. By providing a system accessible from a client device such as a cellular telephone or other similar device, a consumer can request information about a product or service at a point of sale. By providing the information in an easy to use format, the consumer can make informed purchasing decisions. In addition, by providing additional information about similar, but more highly rated products, the consumer is given additional options to consider when making the purchase.

Furthermore, by providing a method of receiving feedback from consumers, the database of consumer information continuously updateable, and provides a method of receiving input from a variety of sources. In addition by providing additional functionality to devices that a large number of consumers already have, the system is more easily implemented and accessible to consumers.

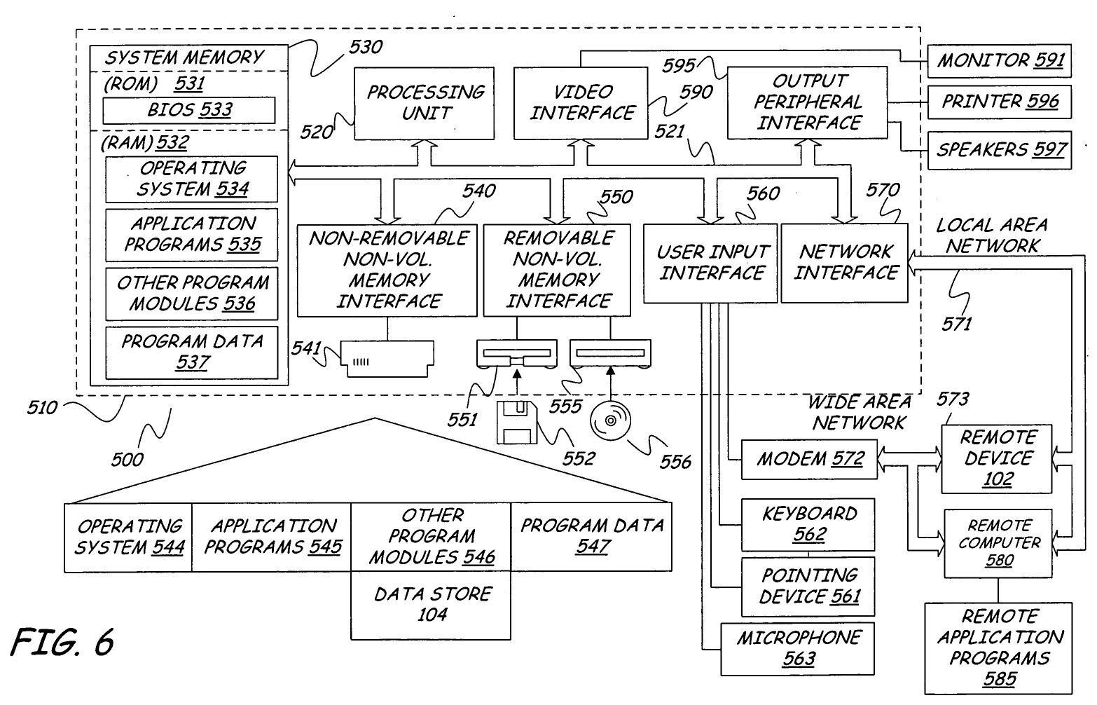

FIG. 6 illustrates an example of a suitable computing system environment 500 on which embodiments may be implemented. The computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary operating environment 500.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 6, an exemplary system for implementing some embodiments includes a general-purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 510. Any of these storage media is capable of providing a data store such as product or service information data store 104. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 6 illustrates operating system 534, application programs 535, other program modules 536, and program data 537.

The computer 510 may also include other removable/non-removable volatile/nonvolatile computer storage media. By way of example only, FIG. 6 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 6, provide storage of computer readable instructions, data structures, program modules and other data for the computer 510. The drives and their associated storage media are suitable to provide the product or service information data store 104. In FIG. 6, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies.

A user may enter commands and information into the computer 510 through input devices such as a keyboard 562, a microphone 563, and a pointing device 561, such as a mouse, trackball or touch pad. Other input devices (not shown) may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 is operated in a networked environment using logical connections to one or more remote computers, such as a remote computer 580. The remote computer 580 may be a personal computer, a hand-held device, a server, a router, a network PC, a peer device or other common network node, and typically includes many or all of the elements described above relative to the computer 510. The logical connections depicted in FIG. 6 include a local area network (LAN) 571 and a wide area network (WAN) 573, but may also include other networks. Such networking environments are commonplace in offices, enterprise-wide computer networks, intranets and the Internet. The WAN 573 is of the type which illustratively provides a communication path between the system 100 and the remote device 102.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 6 illustrates remote application programs 585 as residing on remote computer 580. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of communicating information about a product or service evaluation between a system having a data store and a wireless client device, comprising:
receiving a signal representative of an audible indication from the client device via a wireless communication link identifying the product or service about which evaluation information is to be communicated;
comparing an indication of the signal to data in the data store in response to match the indication with a portion of the data; and
communicating evaluation information between the wireless client device and the system.

2. The method of claim 1 and further comprising:
communicating a signal indicative of a visual indication for identifying the product or service between the client device and the system.

3. The method of claim 1, wherein the evaluation information is communicated from the wireless client device to the system and further comprising:
storing data in the data store related to the evaluation information.

4. The method of claim 3, and further comprising:
communicating information related to an attribute associated with the product or service in response to a prompt from the system after communicating evaluation information to the system.

5. The method of claim 1, wherein the evaluation information is communicated from the system to the wireless client device and further comprising:
communicating information related to an attribute associated with the product or service to the system in response to a prompt from the system after receiving evaluation information from the system.

6. The method of claim 3, and further comprising:
providing a confirmation request to a data server external to the remote client device.

7. The method of claim 1, wherein communicating evaluation information includes communicating information related to at least one numerical value.

8. The method of claim 1, wherein the communicated evaluation information includes information related to at least one textual description of an attribute.

9. The method of claim 1, wherein communicating evaluation information includes communicating information related to an alternative product or service to the product or service identified.

10. The method of claim 9, wherein communicating information related to the alternative product or service is provided in response to previously received consideration.

11. The method of claim 9, wherein communicating information related to the alternative product or service includes communicating advertising information.

12. The method of claim 1, wherein receiving the signal includes receiving an indication of a geographic location of the wireless client and further comprising:
communicating information between the wireless client device and the system related to the geographic location of the wireless client;
identifying a retail establishment associated with the geographic location; and
providing promotional information related to the retail establishment.

13. A system for providing information related to a product or service evaluation to a remote device, comprising:
a data store configured to store data related to a product or service evaluation;
an engine configured to receive a signal indicative of a request for communication from the remove device;
a communication link capable of communicating with a remote device to communicate information related to a product or service evaluation between the data store and the remote device in response to the signal indicative of the request; and
wherein the information is provided to a text to speech engine.

14. The system of claim 13, wherein the engine is configured to receive a communication of product or service information from the remote device.

15. The system of claim 14, wherein the engine is configured to store product or service information in the data store indicative of the communication from the remote device.

16. A method of receiving information related to a product or service evaluation at a wireless telecommunication device remote to a data store that stores the information, comprising:
sending a request signal indicative of the product or service to a system having a data store;
receiving a signal indicative of the information from the system; and
wherein the signal includes information related to a rating of the product or service.

17. The method of claim 16, wherein receiving the signal includes receiving a plurality of ratings and wherein each rating is indicative of an attribute of the product or service.

18. The method of claim 17, wherein receiving the signal includes receiving qualitative information related to the product or service.

19. The method of claim 16 and further comprising:
receiving product or service evaluation information related to a product or service other than the product or service indicated by the request signal.

20. The method of claim 16 and further comprising:
providing product or service evaluation information to related to the product or service to the remote data store.
